(19) United States
(12) Patent Application Publication
(10) Pub. No.: US 2016/0005082 A1
(43) Pub. Date: Jan. 7, 2016

(54) ADVERTISING ACCESSORIES FOR A DIGITAL IMAGING DEVICE

(71) Applicant: LENOVO ENTERPRISE SOLUTIONS (SINGAPORE) PTE. LTD., SINGAPORE (SG)

(72) Inventors: GARY D. CUDAK, WAKE FOREST, NC (US); CHRISTOPHER J. HARDEE, RALEIGH, NC (US); SARBAJIT K. RAKSHIT, KOLKATA (IN)

(21) Appl. No.: 14/324,310

(22) Filed: Jul. 7, 2014

(51) Int. Cl. G06Q 30/02; G06K 9/00; G06Q 30/06

(52) U.S. Cl. CPC G06Q 30/0269; G06Q 30/0631; G06K 9/00744

(57) ABSTRACT

Advertising accessories for a digital imaging device, including: receiving, by an accessory recommendation module, a digital image captured by the digital imaging device; identifying, by the accessory recommendation module, imaging accessories used by the digital imaging device to capture the digital image; identifying, by the accessory recommendation module, an additional imaging accessory not used by the digital imaging device to capture the digital image; and recommending, by the accessory recommendation module, the additional imaging accessory to a user of the digital imaging device.

### BACKGROUND OF THE INVENTION

1. Field of the Invention

The field of the invention is data processing, or, more specifically, methods, apparatus, and products for advertising accessories for a digital imaging device.

2. Description of Related Art

Video cameras and still image cameras have become extremely prevalent. Video cameras and still image cameras may exist as standalone products and may alternatively be embedded within other products such as smartphones, tablet computers, and the like. Video cameras and still image cameras can be equipped with a wide array of accessories that alter or otherwise extend the capabilities of the video camera or the still image camera. Such accessories can frequently enable the photographer or videographer to capture different types of images and videos, as well as many forms of images and videos that represent an improvement over the images or videos that could be captured without the use of such accessories.

### SUMMARY OF THE INVENTION

Methods, apparatuses, and products for advertising accessories for a digital imaging device, including: receiving, by an accessory recommendation module, a digital image captured by the digital imaging device; identifying, by the accessory recommendation module, imaging accessories used by the digital imaging device to capture the digital image; identifying, by the accessory recommendation module, an additional imaging accessory not used by the digital imaging device to capture the digital image; and recommending, by the accessory recommendation module, the additional imaging accessory to a user of the digital imaging device.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in advertising accessories for a digital imaging device according to embodiments of the present invention.

FIG. 2 sets forth a flow chart illustrating an example method for advertising accessories for a digital imaging device according to embodiments of the present invention.

FIG. 3 sets forth a flow chart illustrating an additional example method for advertising accessories for a digital imaging device according to embodiments of the present invention.

FIG. 4 sets forth a flow chart illustrating an additional example method for advertising accessories for a digital imaging device according to embodiments of the present invention.

### DETAILED DESCRIPTION OF EXAMPLE EMBODIMENTS

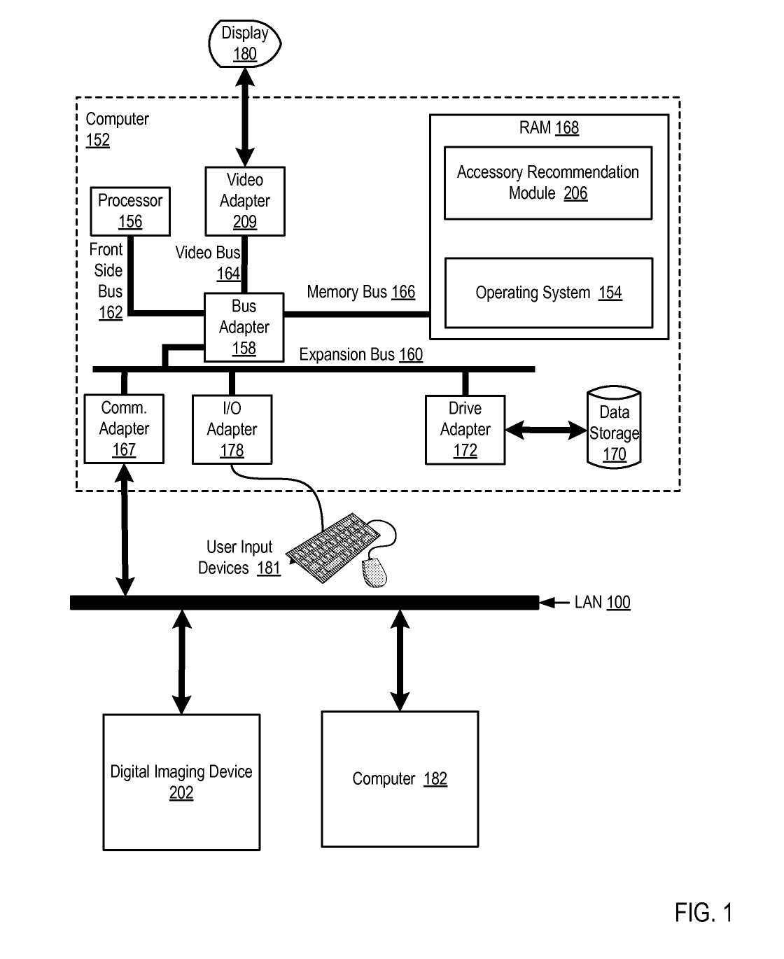

Example methods, apparatuses, and products for advertising accessories for a digital imaging device in accordance with the present invention are described with reference to the accompanying drawings, beginning with FIG. 1. FIG. 1 sets forth a block diagram of automated computing machinery comprising an example computer (152) useful in advertising accessories for a digital imaging device (202) according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is an accessory recommendation module (206), a module of computer program instructions improved for advertising accessories for a digital imaging device (202) according to embodiments of the present invention. The accessory recommendation module (206) may be embodied, for example, as a standalone application executing on computer hardware, as a component of an application such as a social media application executing on computer hardware, as a component of an application such as a digital imaging application executing on computer hardware, and so on.

The accessory recommendation module (206) may be configured to advertise accessories for a digital imaging device (202) by receiving a digital image captured by the digital imaging device (202). Although described herein as a digital image, readers will appreciate that the digital image may be embodied as a still image or one or more moving images such as a digital video. As such, the digital imaging device (202) of FIG. 1 may be embodied as a standalone digital camera, a standalone digital video recorder, a digital camera embedded within another device such as a smartphone or a tablet computer, a digital video recorder embedded within another device such as a smartphone or a tablet computer, an image sensing device such as a webcam that communicates with other computing devices, and so on.

The accessory recommendation module (206) may receive a digital image captured by the digital imaging device (202) via a data communications network. For example, the digital imaging device (202) may be coupled to a data communications network, such that a user of the digital imaging device (202) may initiate a transfer of the digital image from the digital imaging device (202) directly to the accessory recommendation module (206). Alternatively, the user of the digital imaging device (202) may store the digital image on a network connected device such as a laptop or desktop computer, such that the user of the digital imaging device (202) may initiate a transfer of the digital image to the accessory recommendation module (206) via that laptop or desktop computer. In other embodiments, the user of the digital imaging device (202) may upload the digital image to a network application such as a social media application, which may in turn be configured to transmit the digital image to the accessory recommendation module (206). Readers will appreciate the accessory recommendation module (206) may receive the digital image captured by the digital imaging device (202) in many ways in accordance with embodiments of the present invention.

The accessory recommendation module (206) may be further configured to advertise accessories for a digital imaging device (202) by identifying imaging accessories used by the digital imaging device (202) to capture the digital image. The imaging accessories may be embodied as add-ons to the digital imaging device (202) that were utilized by the digital imaging device (202) to capture the digital image. Such imaging accessories can include physical accessories such as, for example, a particular lens, a polarizer, a flash, a tripod, a memory card, a mount harness, a disc reflector, a remote control, and so on. Such imaging accessories can also include software accessories such as, for example, photography software on a device with a built-in camera such as a smartphone or tablet computer that enables capabilities such as zooming, panoramic image capturing, black and white imaging, or other image manipulation or lens manipulation capabilities.

The accessory recommendation module (206) may identify imaging accessories used by the digital imaging device (202) to capture the digital image, for example, by inspecting image data received from the digital imaging device (202). In such an example, the digital imaging device (202) may include metadata in the digital image that describes the digital imaging device (202) as well as accessories used by the digital imaging device (202). Alternatively, the digital imaging device (202) may transmit a message to the accessory recommendation module (206) that includes information describing the digital imaging device (202) as well as accessories used by the digital imaging device (202). In yet another embodiment, the accessory recommendation module (206) may receive information describing the digital imaging device (202) as well as accessories used by the digital imaging device (202) as part of a registration process, through a user interface presented to the user (222) of the digital imaging device (202), and so on. Such information describing the digital imaging device (202) as well as accessories used by the digital imaging device (202) may be embodied as a manufacturer's part number, a descriptor of an accessory, an application name of a software accessory, and so on. In such a way, the accessory recommendation module (206) may identify the imaging accessories that were used by the digital imaging device (202) to capture the digital image through communications with the digital imaging device (202) itself, through communications with a user (222) of the digital imaging device (202), or any combination thereof.

The accessory recommendation module (206) may be further configured to advertise accessories for a digital imaging device (202) by identifying an additional imaging accessory not used by the digital imaging device (202) to capture the digital image. The accessory recommendation module (206) of FIG. 1 may identify an additional imaging accessory not used by the digital imaging device (202), for example, by searching a repository of available imaging accessories that are compatible with the imaging device (202) and identifying those compatible accessories that were not used by the digital imaging device (202) to capture the digital image. In such an example, the accessory recommendation module (206) may maintain or otherwise have access to a repository of available imaging accessories that are compatible with many imaging devices.

The accessory recommendation module (206) may be further configured to advertise accessories for a digital imaging device (202) by recommending the additional imaging accessory to a user of the digital imaging device (202). The accessory recommendation module (206) of FIG. 1 may recommend the additional imaging accessory to a user of the digital imaging device (202), for example, by sending a message to the digital imaging device (202) that is displayed on the digital imaging device, by sending a multimedia message to a phone number associated with the user of the digital imaging device (202), by sending a message to an email address associated with the user of the digital imaging device (202), and so on. In such an example, a recommendation may include, for example, images captured using a similar imaging device that made use of the additional imaging accessory recommended by the accessory recommendation module (206), product information describing the additional imaging accessory recommended by the accessory recommendation module (206), information identifying vendors of the additional imaging accessory recommended by the accessory recommendation module (206), and so on.

Also stored in RAM (168) is an operating system (154). Operating systems useful advertising accessories for a digital imaging device (202) according to embodiments of the present invention include UNIX™, Linux™, Microsoft XP™, AIX™, IBM's i5/OS™, Apple™ iOS, Android OS, and others as will occur to those of skill in the art. The operating system (154) and the accessory recommendation module (206) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for advertising accessories for a digital imaging device (202) according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards, mice, touchscreen displays, and so on. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182), with one or more digital imaging devices (202), and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for advertising accessories for a digital imaging device (202) according to embodiments of the present invention include modems for wired dial-up communications, Ethernet (IEEE 802.3) adapters for wired data communications network communications, 802.11 adapters for wireless data communications network communications, telecommunications adapters for communications over a telecommunications network, and so on.

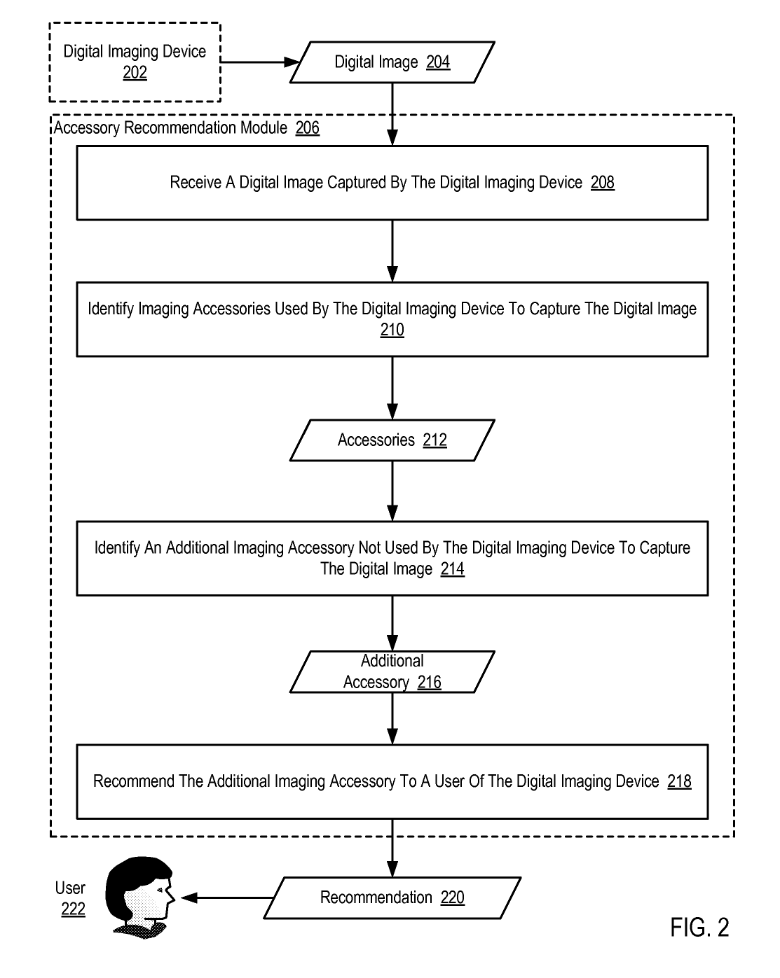

For further explanation, FIG. 2 sets forth a flow chart illustrating an example method for advertising accessories for a digital imaging device (202) according to embodiments of the present invention. The example method depicted in FIG. 2 is carried out, at least in part, by an accessory recommendation module (206). The accessory recommendation module (206) of FIG. 2 may be embodied, for example, as a module of computer program instructions executing on computer hardware such as a computer processor. The accessory recommendation module (206) may be embodied as a standalone application executing on computer hardware, as a component of an application such as a social media application executing on computer hardware, as a component of an application such as a digital imaging application executing on computer hardware, and so on.

The example method depicted in FIG. 2 includes receiving (208), by the accessory recommendation module (206), a digital image (204) captured by the digital imaging device (202). Although described herein as a digital image (204), readers will appreciate that while the digital image (204) of FIG. 2 may be embodied as a standard digital image, the digital image (204) of FIG. 2 may also be embodied as one or more moving images, such the digital image (204) is embodied as a digital video. As such, the digital imaging device (202) of FIG. 2 may be embodied as a standalone digital camera, a standalone digital video recorder, a digital camera embedded within another device such as a smartphone or a tablet computer, a digital video recorder embedded within another device such as a smartphone or a tablet computer, an image sensing device such as a webcam that communicates with other computing devices, and so on.

In the example method depicted in FIG. 2, the accessory recommendation module (206) may receive (208) a digital image (204) captured by the digital imaging device (202) via a data communications network. The digital imaging device (202) of FIG. 2 may be coupled to a data communications network such as a WAN, a LAN, a telecommunications network, or other network, such that a user (222) of the digital imaging device (202) may initiate a transfer of the digital image (204) from the digital imaging device (202) directly to the accessory recommendation module (206). The user (222) of the digital imaging device (202) may alternatively store the digital image (204) on a network connected device such as a laptop or desktop computer, such that the a user (222) of the digital imaging device (202) may initiate a transfer of the digital image (204) to the accessory recommendation module (206) via that laptop or desktop computer. In other embodiments, the user (222) of the digital imaging device (202) may upload the digital image (204) to a network application such as a social media application, which may in turn be configured to transmit the digital image (204) to the accessory recommendation module (206). Readers will appreciate the accessory recommendation module (206) may receive (208) the digital image (204) captured by the digital imaging device (202) in many ways in accordance with embodiments of the present invention.

The example method depicted in FIG. 2 also includes identifying (210), by the accessory recommendation module (206), imaging accessories (212) used by the digital imaging device (202) to capture the digital image (204). The imaging accessories (212) of FIG. 2 may be embodied as add-ons to the digital imaging device (202) that were utilized by the digital imaging device (202) during the process of the digital imaging device (202) capturing the digital image (204). Such imaging accessories (212) can include physical accessories such as, for example, a particular lens, a polarizer, a flash, a tripod, a memory card, a mount harness, a disc reflector, a remote control, and so on. Such imaging accessories (212) can also include software accessories such as, for example, photography software on a device with a built-in camera such as a smartphone or tablet computer that enables capabilities such as zooming, panoramic image capturing, black and white imaging, or other image manipulation or lens manipulation capabilities.

The accessory recommendation module (206) may identify (210) imaging accessories (212) used by the digital imaging device (202) to capture the digital image (204), for example, by inspecting image data received from the digital imaging device (202). In such an example, the digital imaging device (202) may include metadata in the digital image (204) that describes the digital imaging device (202) as well as accessories used by the digital imaging device (202). Alternatively, the digital imaging device (202) may transmit a message to the accessory recommendation module (206) that includes information describing the digital imaging device (202) as well as accessories used by the digital imaging device (202). In yet another alternative embodiment, the accessory recommendation module (206) may receive information describing the digital imaging device (202) as well as accessories used by the digital imaging device (202) as part of a registration process, through a user interface presented to the user (222) of the digital imaging device (202), and so on. Such information describing the digital imaging device (202) as well as accessories used by the digital imaging device (202) may be embodied as a manufacturer's part number, a descriptor of an accessory, an application name of a software accessory, and so on. In such a way, the accessory recommendation module (206) may identify (210) the imaging accessories (212) that were used by the digital imaging device (202) through communications with the digital imaging device (202) itself, through communications with a user (222) of the digital imaging device (202), or any combination thereof.

The example method depicted in FIG. 2 also includes identifying (214), by the accessory recommendation module (206), an additional imaging accessory (216) not used by the digital imaging device (202) to capture the digital image (204). The accessory recommendation module (206) of FIG. 2 may identify (214) an additional imaging accessory (216) not used by the digital imaging device (202), for example, by searching a repository of available imaging accessories that are compatible with the imaging device (202) and identifying those compatible accessories that were not used by the digital imaging device (202) to capture the digital image (204). In such an example, the accessory recommendation module (206) may maintain or otherwise have access to a repository of available imaging accessories that are compatible with many imaging devices.

The example method depicted in FIG. 2 also includes recommending (218), by the accessory recommendation module (206), the additional imaging accessory (216) to a user (222) of the digital imaging device (202). The accessory recommendation module (206) of FIG. 2 may recommend (218) the additional imaging accessory (216) to a user (222) of the digital imaging device (202), for example, by sending a message to the digital imaging device (202) that is displayed on the digital imaging device, by sending a multimedia message to a phone number associated with the user (222) of the digital imaging device (202), by sending a message to an email address associated with the user (222) of the digital imaging device (202), and so on. In such an example, the recommendation (220) may include images captured using a similar imaging device that made use of the additional imaging accessory (216) recommended (218) by the accessory recommendation module (206), product information describing the additional imaging accessory (216) recommended (218) by the accessory recommendation module (206), information identifying vendors of the additional imaging accessory (216) recommended (218) by the accessory recommendation module (206), and so on.

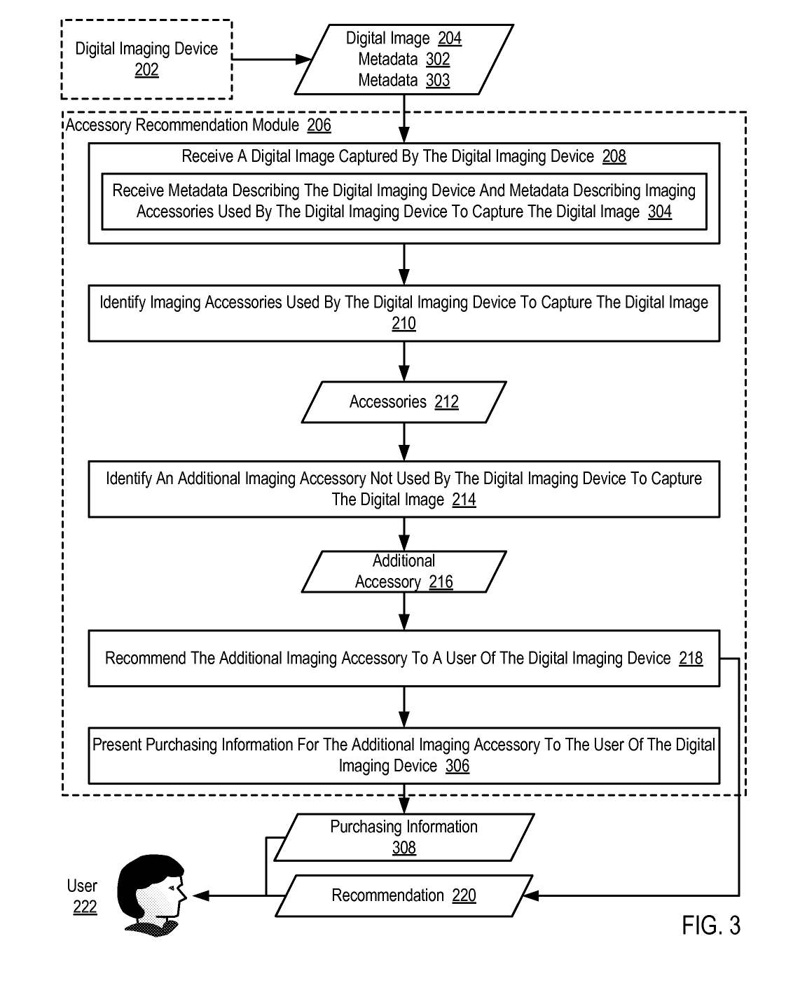

For further explanation, FIG. 3 sets forth a flow chart illustrating an additional example method for advertising accessories for a digital imaging device (202) according to embodiments of the present invention. The example method depicted in FIG. 3 is similar to the example method depicted in FIG. 2, as the example method depicted in FIG. 3 also includes receiving (208) a digital image (204) captured by the digital imaging device (202), identifying (210) imaging accessories (212) used by the digital imaging device (202) to capture the digital image (204), identifying (214) an additional imaging accessory (216) not used by the digital imaging device (202) to capture the digital image (204), and recommending (218) the additional imaging accessory (216) to a user (222) of the digital imaging device (202).

In the example method depicted in FIG. 3, receiving (208) a digital image (204) captured by the digital imaging device (202) can include receiving (304) metadata (302) describing the digital imaging device (202) and metadata (303) describing imaging accessories (212) used by the digital imaging device (202) to capture the digital image (204). The metadata (302) describing the digital imaging device (202) can include, for example, information identifying a manufacturer of the digital imaging device (202), a model number of the digital imaging device (202), a software version (e.g., operating system version) that is controlling the operation of the digital imaging device (202), information describing the capabilities of the digital imaging device (202), and so on. Such information may programmed in to the digital imaging device (202) by the manufacturer, received from a user (222) of the digital imaging device (202) through a GUI presented by the accessory recommendation module (206), discovered through a discovery process that is executed when a digital imaging device (202) is initially registered with the accessory recommendation module (206), or obtained in other ways. Such information may be subsequently sent from the digital imaging device (202) to the accessory recommendation module (206) as metadata contained in a message that includes the digital image (204), as metadata that is included in a file that includes digital image (204), and so on.

The metadata (303) describing imaging accessories (212) used by the digital imaging device (202) to capture the digital image (204) may include, for example, information identifying a manufacturer of imaging accessories (212) used by the digital imaging device (202), a model number of imaging accessories (212) used by the digital imaging device (202), a software version (e.g., version number of photography software) that is used by the digital imaging device (202), information describing the capabilities of the imaging accessories (212) used by the digital imaging device (202), and so on. Such information may be programmed in to the imaging accessories (212) by the manufacturer of the imaging accessories (212), received from a user (222) of the digital imaging device (202) through a GUI presented by the accessory recommendation module (206), discovered through a discovery process that is executed when a digital imaging device (202) is initially registered with the accessory recommendation module (206), or obtained in other ways. Such information may be sent from the digital imaging device (202) to the accessory recommendation module (206) as metadata contained in a message that includes the digital image (204), as metadata that is included in a file that includes digital image (204), and so on.

The example method depicted in FIG. 3 also includes presenting (306), by the accessory recommendation module (206), purchasing information (308) for the additional imaging accessory (216) to the user (222) of the digital imaging device (202). The purchasing information (308) for the additional imaging accessory (216) may be embodied, for example, as a list of vendors that sell the additional imaging accessory (216), as a link to an online store that sells the additional imaging accessory (216), and so on. Such purchasing information (308) for the additional imaging accessory (216) can include information identifying the availability of the additional imaging accessory (216), the price of the additional imaging accessory (216), and so on. In such an example, the accessory recommendation module (206) may be configured to communicate with online retailers or otherwise receive information from online retailers identifying various products offered for sale by the online retailers, such that the accessory recommendation module (206) can identify those online retailers that offer the additional imaging accessory (216) for sale, for rent, and so on.

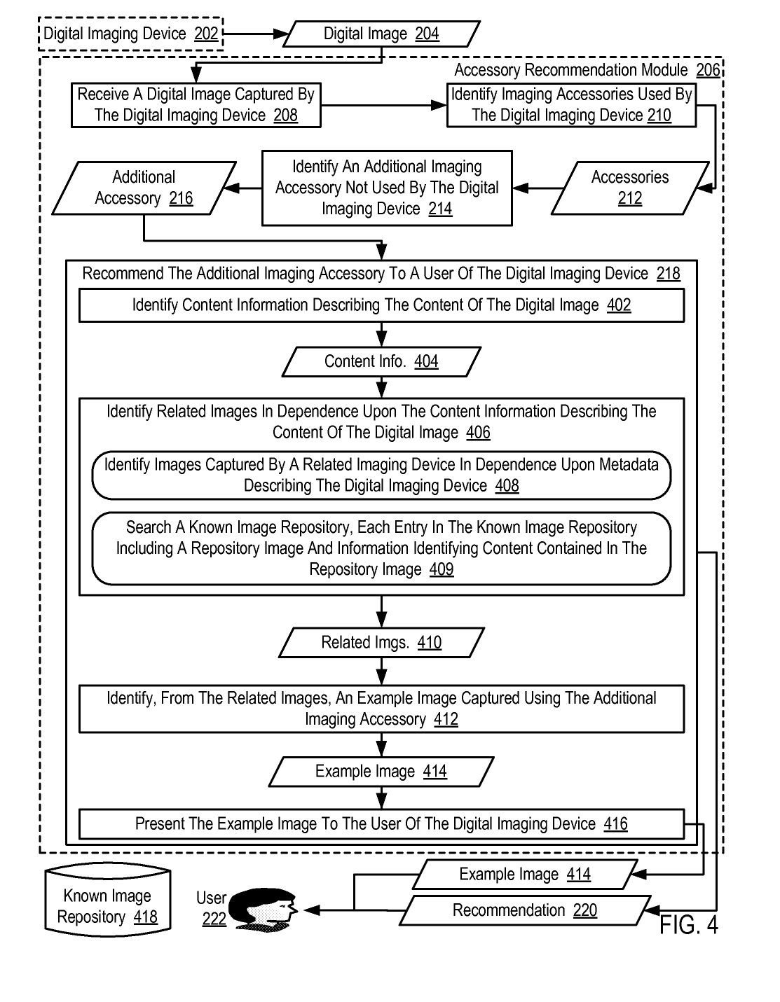

For further explanation, FIG. 4 sets forth a flow chart illustrating an additional example method for advertising accessories for a digital imaging device (202) according to embodiments of the present invention. The example method depicted in FIG. 4 is similar to the example method depicted in FIG. 2, as the example method depicted in FIG. 4 also includes receiving (208) a digital image (204) captured by the digital imaging device (202), identifying (210) imaging accessories (212) used by the digital imaging device (202) to capture the digital image (204), identifying (214) an additional imaging accessory (216) not used by the digital imaging device (202) to capture the digital image (204), and recommending (218) the additional imaging accessory (216) to a user (222) of the digital imaging device (202).

In the example method depicted in FIG. 4, recommending (218) the additional imaging accessory (216) to a user (222) of the digital imaging device (202) can include identifying (402), by the accessory recommendation module (206), content information (404) describing the content of the digital image (204). The content of the digital image (204) can include, for example, known landmarks (e.g., The Statue of Liberty) that appear in the digital image (204), particular types of features (e.g., mountains, oceans, beaches, lakes, skylines, people) that appear in the digital image (204), and so on. The accessory recommendation module (206) depicted in FIG. 4 may identify (402) content information (404) describing the content of the digital image (204), for example, by receiving input from the user (222) that identifies categories of content that are contained in the captured digital image (204), by maintaining a catalog of known landmarks and comparing the captured digital image (204) to each entry in the catalog of known landmarks, by otherwise comparing the captured digital image (204) to a repository of images that are associated with different categories of content, by inspecting metadata associated with the captured image (204) that identify aspects of the content contained in the captured digital image (204), and so on.

In the example method depicted in FIG. 4, recommending (218) the additional imaging accessory (216) to a user (222) of the digital imaging device (202) can also include identifying (406), by the accessory recommendation module (206), related images (410) in dependence upon the content information (404) describing the content of the digital image (204). The related images (410) of FIG. 4 represent images that include content that is similar to or otherwise related to the content of the digital image (204) captured by the digital imaging device (202). For example, if the content of the digital image (204) captured by the digital imaging device (202) included a still image of Mount Rushmore, other images of Mount Rushmore may be characterized as being related images (410). Likewise, if the content of the digital image (204) captured by the digital imaging device (202) included a still image of a waterfall, other images of waterfalls may be characterized as being related images (410).

In the example method depicted in FIG. 4, identifying (406) related images (410) in dependence upon the content information (404) describing the content of the digital image (204) can include searching (409), by the accessory recommendation module (206), a known image repository (418). The known image repository (418) may be embodied as a database or other data repository for maintaining a body of previously captured images whose content is known. In such an example, each entry in the known image repository (418) may therefore include a repository image that is embodied, for example, as a digital image, a digital video, and so on. Each entry in the known image repository (418) may also include information identifying the content contained in the repository image. Information identifying the content contained in the repository image may include, for example, metadata identifying a particular landmark contained in the associated repository image, metadata identifying a particular type of natural feature contained in the associated repository image, metadata identifying a particular object contained in the associated repository image, and so on. Readers will appreciate that each entry in the known image repository (418) may associate a plurality of different types of content contained in a particular repository image with a single repository image.

The accessory recommendation module (206) of FIG. 4 may therefore identify (406) related images (410) in dependence upon the content information (404) describing the content of the digital image (204) by searching all entries in the known image repository (418) that is maintained or otherwise accessible to the accessory recommendation module (206). In such a way, the information identifying the content contained in the repository image associated with each entry in the known image repository (418) may be compared to the content information (404) describing the content of the digital image (204) to identify (406) a match. If a match is identified, the associated repository image may be deemed to be a related image (410) of the digital image (204) captured by the digital imaging device (202).

In the example method depicted in FIG. 4, identifying (406) related images (410) in dependence upon the content information (404) describing the content of the digital image (204) can further include identifying (408), by the accessory recommendation module (206), images captured by a related imaging device in dependence upon metadata (302 of FIG. 3) describing the digital imaging device (202). In the example method depicted in FIG. 4, each entry in the known image repository (418) may also include information identifying the device that captured a repository image associate with a particular entry. The information identifying the device that captured a repository image associated with a particular entry may include, for example, a manufacturer's model number of the digital imaging device that captured the repository image associated with the known image repository (418) entry. By utilizing such information, the accessory recommendation module (206) can restrict the pool of images that can potentially qualify as related images (410) to those images that were captured using an imaging device that is sufficiently similar to the imaging device (202) that captured the digital image (204).

In the example method depicted in FIG. 4, recommending (218) the additional imaging accessory (216) to a user (222) of the digital imaging device (202) can also include identifying (412), by the accessory recommendation module (206) from the related images (410), an example image (414) captured using the additional imaging accessory (216). Each of the related images (410) may include, or otherwise be associated with, information that describes the accessories that were used to capture the related image (410). As such, the accessory recommendation module (206) may identify those related images (410) that were captured utilizing a particular additional imaging accessory (216). In such a way, the accessory recommendation module (206) may designate one of the related images (410) that were captured utilizing the additional imaging accessory (216) as an example image (414) that depicts the benefit of utilizing the additional imaging accessory (216). In the event that a plurality of the related images (410) were captured utilizing the additional imaging accessory (216), the accessory recommendation module (206) may utilize user ratings or other criteria to identify (412) an example image (414) captured using the additional imaging accessory (216) from the related images (410).

In the example method depicted in FIG. 4, recommending (218) the additional imaging accessory (216) to a user (222) of the digital imaging device (202) can also include presenting (416), by the accessory recommendation module (206), the example image (414) to the user (222) of the digital imaging device (202). The accessory recommendation module (206) may present (416) the example image (414) to the user (222) of the digital imaging device (202), for example, by displaying the example image (414) on a display screen of the digital imaging device (202), by sending the example image (414) to an email address associated with the user (222) of the digital imaging device (202), by sending the example image (414) in a multimedia message to a phone number associated with the user (222) of the digital imaging device (202), and so on. In such an example, the example image (414) can include information identifying the digital imaging device (202) and the particular additional accessory (216) that were used to capture the example image (414), such that the user (222) of the digital imaging device (202) can compare the example image (414) to the digital image (204) captured using the digital imaging device (202) to compare the image quality or image features that can be obtained using the additional accessory (216).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a standalone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of advertising accessories for a digital imaging device, the method comprising:
receiving, by an accessory recommendation module, a digital image captured by the digital imaging device;
identifying, by the accessory recommendation module, imaging accessories used by the digital imaging device to capture the digital image;
identifying, by the accessory recommendation module, an additional imaging accessory not used by the digital imaging device to capture the digital image; and
recommending, by the accessory recommendation module, the additional imaging accessory to a user of the digital imaging device.

2. The method of claim 1 wherein receiving the digital image captured by the digital imaging device further comprises receiving metadata describing the digital imaging device and metadata describing imaging accessories used by the digital imaging device to capture the digital image.

3. The method of claim 1 wherein recommending the additional imaging accessory to the user of the digital imaging device further comprises:
identifying, by the accessory recommendation module, content information describing the content of the digital image;
identifying, by the accessory recommendation module, related images in dependence upon the content information describing the content of the digital image;
identifying, by the accessory recommendation module from the related images, an example image captured using the additional imaging accessory; and
presenting, by the accessory recommendation module, the example image to the user of the digital imaging device.

4. The method of claim 3 wherein identifying related images in dependence upon the content information describing the content of the digital image further comprises identifying, by the accessory recommendation module, images captured by a related imaging device in dependence upon metadata describing the digital imaging device.

5. The method of claim 3 wherein identifying related images in dependence upon the content information describing the content of the digital image further comprises searching, by the accessory recommendation module, a known image repository, each entry in the known image repository including a repository image and information identifying content contained in the repository image.

6. The method of claim 1 further comprising presenting, by the accessory recommendation module, purchasing information for the additional imaging accessory to the user of the digital imaging device.

7. An apparatus for advertising accessories for a digital imaging device, the apparatus comprising a computer processor, a computer memory operatively coupled to the computer processor, the computer memory having disposed within it computer program instructions that, when executed by the computer processor, cause the apparatus to carry out the steps of:
receiving, by an accessory recommendation module, a digital image captured by the digital imaging device;
identifying, by the accessory recommendation module, imaging accessories used by the digital imaging device to capture the digital image;
identifying, by the accessory recommendation module, an additional imaging accessory not used by the digital imaging device to capture the digital image; and
recommending, by the accessory recommendation module, the additional imaging accessory to a user of the digital imaging device.

8. The apparatus of claim 7 wherein receiving the digital image captured by the digital imaging device further comprises receiving metadata describing the digital imaging device and metadata describing imaging accessories used by the digital imaging device to capture the digital image.

9. The apparatus of claim 7 wherein recommending the additional imaging accessory to the user of the digital imaging device further comprises:
identifying, by the accessory recommendation module, content information describing the content of the digital image;
identifying, by the accessory recommendation module, related images in dependence upon the content information describing the content of the digital image;
identifying, by the accessory recommendation module from the related images, an example image captured using the additional imaging accessory; and
presenting, by the accessory recommendation module, the example image to the user of the digital imaging device.

10. The apparatus of claim 9 wherein identifying related images in dependence upon the content information describing the content of the digital image further comprises identifying, by the accessory recommendation module, images captured by a related imaging device in dependence upon metadata describing the digital imaging device.

11. The apparatus of claim 9 wherein identifying related images in dependence upon the content information describing the content of the digital image further comprises searching, by the accessory recommendation module, a known image repository, each entry in the known image repository including a repository image and information identifying content contained in the repository image.

12. The apparatus of claim 7 further comprising computer program instructions that, when executed by the computer processor, cause the apparatus to carry out the step of presenting, by the accessory recommendation module, purchasing information for the additional imaging accessory to the user of the digital imaging device.

13. A computer program product for advertising accessories for a digital imaging device, the computer program product disposed upon a computer readable medium, the computer program product comprising computer program instructions that, when executed, cause a computer to carry out the steps of:
receiving, by an accessory recommendation module, a digital image captured by the digital imaging device;
identifying, by the accessory recommendation module, imaging accessories used by the digital imaging device to capture the digital image;
identifying, by the accessory recommendation module, an additional imaging accessory not used by the digital imaging device to capture the digital image; and
recommending, by the accessory recommendation module, the additional imaging accessory to a user of the digital imaging device.

14. The computer program product of claim 13 wherein receiving the digital image captured by the digital imaging device further comprises receiving metadata describing the digital imaging device and metadata describing imaging accessories used by the digital imaging device to capture the digital image.

15. The computer program product of claim 13 wherein recommending the additional imaging accessory to the user of the digital imaging device further comprises:
identifying, by the accessory recommendation module, content information describing the content of the digital image;
identifying, by the accessory recommendation module, related images in dependence upon the content information describing the content of the digital image;
identifying, by the accessory recommendation module from the related images, an example image captured using the additional imaging accessory; and
presenting, by the accessory recommendation module, the example image to the user of the digital imaging device.

16. The computer program product of claim 15 wherein identifying related images in dependence upon the content information describing the content of the digital image further comprises identifying, by the accessory recommendation module, images captured by a related imaging device in dependence upon metadata describing the digital imaging device.

17. The computer program product of claim 15 wherein identifying related images in dependence upon the content information describing the content of the digital image further comprises searching, by the accessory recommendation module, a known image repository, each entry in the known image repository including a repository image and information identifying content contained in the repository image.

18. The computer program product of claim 13 further comprising computer program instructions that, when executed, cause the computer to carry out the step of presenting, by the accessory recommendation module, purchasing information for the additional imaging accessory to the user of the digital imaging device.

19. The computer program product of claim 13 wherein the computer readable medium comprises a signal medium.

20. The computer program product of claim 13 wherein the computer readable medium comprises a storage medium.
